(19) United States
(12) Patent Application Publication
(10) Pub. No.: US 2005/0176598 A1
(43) Pub. Date: Aug. 11, 2005

(54) Compositions and method for targeted controlled delivery of active ingredients and sensory markers onto hair, skin and fabric

(76) Inventors: Catharine J. Bergquist, Woodbridge, NJ (US); Daniel Stauffer, Lawrenceville, NJ (US); Paul M. Ferm, Morristown, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/038,296

(22) Filed: Jan. 19, 2005

Related U.S. Application Data
(63) Continuation-in-part of application No. 10/222,054, filed on Aug. 16, 2002.
Application No. 10/222,054 is a continuation of application No. 09/771,752, filed on Jan. 29, 2001, now Pat. No. 6,491,902.

(51) Int. Cl. C11D 3/50

(52) U.S. Cl. 510/101

(57) ABSTRACT

The present invention relates to a controlled delivery system that can be incorporated in liquid, as well as, dry granular, or powder, household products, such as dishwashing detergents, surface cleaners, deodorizers, animal litters and cleaning wipes The system also prolongs the release rate of the active agents over an extended period of time, or provides heat triggered release of the active agents and yields a high impact fragrance “burst” upon heat treatment. The controlled delivery system of the present invention is a nano-sphere, having an average sphere diameter of from about 0.01 microns to about 10 microns. The nano-sphere comprises hydrophobic materials, cationic conditioning agent or, cationic conditioning agent in conjunction with a cationic charge booster to assist in adhering the spheres onto a surface.

### CROSS REFERENCE TO RELATED APPLICATION

This application is a continuation-in-part of U.S. patent application Ser. No. 10/222,054 filed Aug. 16, 2002, which is a continuation of U.S. patent application Ser. No. 09/771,752 filed Jan. 29, 2001, now U.S. Pat. No. 6,491,902. The entirety of each is hereby incorporated by reference into this application.

### BACKGROUND OF THE INVENTION

1. Field of the Invention

The present invention relates to a controlled release carrier system that can be incorporated into household products, such as cleaning compositions, dishwashing detergent formulations, deodorizer formulations, animal litter and cleaning wipes, and other household products, and that enhances fragrance deposition and which provides prolonged release of an active agent, such as a fragrance over an extended period of time.

2. Description of the Related Art

The household industry has searched for many years for ways to enhance the performance of household products and make them more aesthetically pleasing for the consumers. Consumer acceptance of household products is determined not only by the performance achieved with these products but the aesthetics associated therewith. Fragrance is an important aspect of the successful household products and they are being utilized, in addition to imparting an aesthetically pleasing odor, to convey to the consumer the product performance and effectiveness (i.e., the surface is clean, etc.).

Fragrances are typically added to household products to provide a fresh, clean impression for these products. While the fragrance may not add to the performance of the household products, it does make these products more aesthetically pleasing and the consumer has come to expect such products to have a pleasing odor. The fragrance plays a major, and often determining, role for the consumer in selecting and purchasing the household product. Consumers are becoming increasingly educated and expect a high level of sophistication in their household products. Many consumers would prefer for the fragrance, present in these products, to be deposited and remain there for an extended period of time to convey a lasting impression of freshness. Consumers are also interested in household products that deposit high level of fragrance. Fragrance creation for household products is restricted not only by considerations such as availability and cost, but also by compatibility of the fragrance ingredients with other components in the product composition.

U.S. Pat. No. 4,402,856 describes the use of coacervation technique to create perfume particles for diverse products including washing agents, household agents and cellulose nappies composed of gelatin or a mixture of gelatin with gum arabic, carboxymethylcellulose and/or anionic polymers. The gelatin is hardened with a natural and/or synthetic tanning agent and with a carbonyl compound.

U.S. Pat. No. 4,919,841 discloses wax encapsulated actives based on emulsion process for household applications including fabric. The process for preparing encapsulated active particles comprises the steps of: dispersing active materials in molten wax; emulsifying the active/wax dispersion in aqueous surfactant solution; quenching the capsules by cooling; and retrieving solidified capsules. The active materials may be selected from chlorine or oxygen bleaching agents, bleach precursors, enzymes, perfumes, fabric softening agents, and surfactants. The resultant capsules are in a form of dispersion (liquid) and have utility for cleaning compositions such as automatic dishwashing detergent formulations.

U.S. Pat. No. 6,042,792 issued to the inventor of this disclosure also describes an aqueous dispersion. A controlled, time-release microparticulate active and bioactive compositions (including perfuming compositions) for targeted delivery to services such as skin, hair and fabric and the environment proximate thereto is described in which the active and bioactive materials have a calculated log P values of between 1 and 8 (P being the n-octanol-water partition coefficient). Such compositions include the active or bioactive material in single phase, solid solution in a wax or polymer matrix also having coated thereon and/or containing a compatible surfactant. Also described are processes and apparatus for preparing such compositions and processes for using same.

Water soluble polymers have also been used to encapsulate fragrance oils. Such capsules have proved useful in releasing perfume in deodorants. However, such capsules have not been commercially successful in extended release of perfume from fabrics. U.S. Pat. No. 5,425,887 discloses an encapsualted perfume system in tumble dryer articles. The encapsulating material is a water-soluble natural or synthetic polymer with a molecular weight of less than about 300,000 that will release the perfume in response to moisture. Since these systems are water sensitive, these types of particles cannot be incorporated in aqueous fabric softener compositions.

U.S. Pat. Nos. 5,066,419 and 5,154,842 disclose coated perfume particles. The perfume particles comprise perfume dispersed within certain water-insoluble non-polymeric carrier materials and encapsulated in a protective shell by coating with a friable coating material. The coated particles allow for preservation and protection of perfumes, which are susceptible to degradation or loss in storage and in cleaning compositions. In use, the surface coating fractures and the underlying carrier/perfume particles deliver a large variety of perfume types to fabrics or other surfaces.

U.S. Pat. Nos. 4,973,422 and 5,137,646 disclose perfume particles for use in cleaning and conditioning compositions. Perfume particles are disclosed comprising perfume dispersed within wax materials. The particles can be further coated with a material that makes the particles more substantive to the surface being treated. Such materials help to deliver the particles and maximize perfume release. Generally, the coating materials are water-insoluble cationic materials. Cleaning and conditioning compositions comprising these perfume particles are also disclosed.

U.S. Pat. No. 6,024,943 discloses particles containing absorbed liquids and methods of making them. Perfume is absorbed within organic polymer particles, which have a further polymer at their exterior. The polymer incorporates free hydroxyl groups and serves to promote deposition of the particles from a wash or rinse liquor. The polymer may be part of an encapsulating shell, but more conveniently is used as a stabilizer during polymerization of the particles. Highly hydrolyzed polyvinyl alcohol is preferred. Particles containing organic polymer, which are insoluble in water, with liquid imbibed by the particles, the particles having at their exterior, a polymer which incorporates free hydroxy groups.

U.S. Pat. No. 5,476,660 discloses compositions to deposit an active substance on a target surface. The active substance is left on the surface after the product is rinsed off the surface. The preferred deposition is from compositions containing an anionic or nonionic active in the co-presence of an anionic surfactant. The compositions contain carrier particles having a zwitterionic or cationic surface and a plurality of outwardly protruding filaments containing charged organocarbyl groups. The term “zwitterionic” employed in this patent means a mixture of cationic and anionic (not necessarily neutral); thus the surface of the zwitterionic particles, have both cationic and anionic groups (i.e., positively charged and negatively charged organocarbyl groups). The active substance is contained within the carrier particles. Examples of target surfaces are mammalian skin, hair or nails.

U.S. Pat. No. 6,362,159 describes a domestic care particle comprising a fragrance particle. The particle comprises a fragrance composition and at least one silicone polymer provided at least 20% of the silicone atom in the silicone polymer have a substituent of 16 carbon atoms or more.

WO 03/083031 discloses a blend of a fragrance composition and a mixture of a wax and a liquid silicone compatible with the wax. An emulsion can be formed by emulsifying the blend in the continuous phase using at least one surfactant. The emulsion can be dispersed in a liquid cleaning product. Alternatively, the blend can be emulsified in the liquid cleaning product.

The prior art of which applicant is aware does not set forth a fragrance controlled release system that can be incorporated in liquid, as well as, dry granular, or powder, household products to enhance fragrance performance. There is also a need for a fragrance carrier system, for household products or wipes, that will allow using a wider range of fragrance ingredients and improved fragrance substantivity and longevity. It is desirable to provide a control release system for overcoming these limitations. It is also desirable to provide a method using an efficient and economical process for delivering a broad range of fragrance ingredients from a household product and prolong fragrance release over an extended period of time.

### SUMMARY OF THE INVENTION

The present invention relates to a targeted controlled release composition in the form of nano spheres for targeted controlled delivery of active ingredients and sensory markers onto hair, skin, and fabric. The targeted controlled release system of the present invention is a dispersion of solid hydrophobic nano-spheres that has high cationic charge density to target and enhances the deposition of the nano-sphere onto the target site. The high cationic charge density of these nano-spheres is created by incorporating a cationic conditioning agent into the solid hydrophobic matrix of the nano-spheres or by incorporating a cationic conditioning agent into the solid hydrophobic matrix of the nano-spheres in conjunction with a cationic charge “booster” in the aqueous phase. The present invention meets the aforementioned needs in that it has been discovered that the use of combination of cationic surfactants with cationic charge booster, especially polyethyleneimine (or other polyamines, homogeneous or non-homogeneous polyamine backbones, preferably homogeneous backbones) can “boost” charge density of particles and provide enhanced deposition of particles onto hair, skin, and fabric. It has been discovered that the addition of a cationic charge boosting polymer can significantly increase the charge density of particles, to a level which enhances deposition of particles onto hair. The most effective deposition of particles onto hair is achieved by admixing cationic surfactants with a polyamine, such as polyethyleneimine, a cationic charge booster, branched, spherical, and cationic polyethyleneimine.

The present invention relates to a targeted controlled release system that effectively delivers a broad range of active ingredients and sensory markers onto hair, hair follicles, skin, and fabric as well as prolongs their release rate over an extended period of time, or provides heat triggered release of active ingredients and high impact fragrance “burst” upon blow drying the hair or ironing the fabric. The invention further relates to skin, hair, and fabric care products comprising the targeted controlled release system of the present invention.

The targeted controlled release system of the present invention can be incorporated into hair, hair follicles, skin, and fabric care products, such as shampoos, conditioners, hair styling products, hair sculpting products, lotions, creams, body wash, liquid laundry detergents, fabric softeners, and other hair, skin, and fabric care products The controlled delivery system of the present invention is a nano-sphere having a solid cationic inner core that confers several advantages as compared with conventional microspheres, lipospheres, and vesicles, including high dispersibility in an aqueous medium, and a release rate for the entrapped substance that is controlled by the hydrophobic material barrier properties. There are also many advantages over other suspension-based delivery systems. Nano-spheres have increased stability as compared to emulsion-based delivery systems, including vesicles and liposomes, and are more effectively dispersed than most suspension based systems. Further, the substance to be delivered does not have to be soluble in the vehicle since it can be dispersed in the solid matrix. The nano-spheres of the present invention also have a lower risk of reaction of substance to be delivered with the vehicle than in emulsion systems because the vehicle is a solid inert material. Moreover, altering the inner solid core can manipulate the release rate of the substance from the nano-spheres. Nano-spheres are also easier to prepare than structured vehicles such as lipospheres, and are inherently more stable.

The nano-spheres of the present invention have an improved mechanism to enhance the deposition of the spheres onto hair, skin, and fabric. The highly cationic charge density characterizing the nano-spheres of the present invention, achieved by the use of cationic conditioning agents in the solid nano spheres or by using a cationic conditioning agent in solid nano-sphere in conjunction with cationic charge booster in the aqueous phase improves the deposition of these spheres onto hair, skin, and fabric and prevents them from being washed off during the rinse process. The nano-spheres of the present invention are believed to attach to the hair, skin, and fabric surfaces via entrapment, hydrophobic interactions, and complexing interaction between the cationic charge group of the spheres and the proteinaceous portion of the hair and skin and thus predispose or condition the surface of the hair and skin so that the nano-spheres will then adhere to the surface.

The nano spheres of the present invention are prepared by high shear homogenization without the need of emulsifier or surface-active materials in the aqueous phase and thus, enhance the efficacy of the encapsulation process and reduce the amount of active ingredients or sensory markers partitioning into the aqueous phase during processing of the system. The use of a surfactant in the aqueous phase during high shear homogenization has a pronounced effect on the encapsulation efficacy of active ingredients in the delivery system in the form of dispersion and emulsion. The micellar formation of the surfactants presence in the aqueous phase of these systems acts as a sink for the active ingredients encapsulated in the nano spheres and promotes partition of active ingredients from the nano sphere matrix into the water phase during processing of these systems and during the product shelf life.

In one embodiment, the present invention provides an improved controlled delivery system for hair, skin, and fabric care products, that improves the substantivity of active ingredients and sensory markers onto hair, skin, and fabric by means of bringing the spheres onto the hair, skin, and fabric through treating the hair, skin, and fabric with hair, skin, and fabric care products respectively comprising the nano-spheres of the present invention. In the industry, the term “substantivity” refers to the deposition of the active ingredients or sensory markers (i.e., fragrance) on the hair, skin, and fabric and the retention and perception of the fragrance on surfaces treated with hair, skin, and fabric care product. Spheres comprising the cationic conditioning agent either in the sphere composition, or spheres comprising cationic conditioning agent in the nano sphere solid matrix in conjunction with a cationic charge boosters in the aqueous phase (at the spheres outer surface), were observed to be highly substantive on surfaces such as skin, hair, and fabric.

The delivery system of the present invention enhances the deposition of active agents and sensory markers onto hair, skin, and fabric prolongs their release rate over an extended period of time, or release them upon heat treatment such as blow drying the hair or ironing the fabric. In addition, the release rate of the active agents is synchronized with that of a sensory marker (i.e., fragrance) to convey to the consumer the product performance.

It has been found that increasing the cationic charge density of the spheres through the use of cationic charge boosters in conjunction with cationic conditioning agents enhances the adhesion of the spheres onto hair, skin, and fabric. In addition, by incorporating cationic surface-active agents into the nano-spheres composition, the system provides improved compatibility of a wide range of active agents and sensory markers in the delivery system, and increases the substantivity of actives that are currently not substantive on hair, skin, and fabric.

Nothing in the prior art, which the applicant is aware of discloses targeted controlled release compositions of solid hydrophobic nano-spheres that have high cationic charge density to target and enhance the deposition of the nano-sphere onto the target site by incorporating a cationic conditioning agent into the solid hydrophobic matrix of the nano-spheres or by incorporating a cationic conditioning agent into the solid hydrophobic matrix of the nano-spheres in conjunction with a cationic charge “booster” in the aqueous phase, and the processing of the system does not require the use of emulsifier or surface-active materials in the aqueous phase and thus, enhance the efficacy of the encapsulation process and reduce the amount of active ingredients or sensory markers partitioning into the aqueous phase during processing of the system. The prior art of which applicant is aware does not set forth a controlled release system which synchronizes the release rate of the active ingredients with that of fragrances or sensory markers to convey the consumer the product performance.

The nano-spheres of the present invention are characterized by:
(i) protection of the active ingredients and sensory markers during storage, until needed;
(ii) enhanced deposition of the active ingredients and sensory markers onto hair, skin, and fabric; the release rate of the active ingredients is synchronized with that of a sensory marker;
(iii) prolong release of the active ingredients and sensory markers over an extended period of time; or
(iv) heat triggered release of the active ingredients and high impact fragrance “burst” upon blow drying the hair or ironing the fabric.

The invention also provides a process for producing the nano-spheres of the present invention that comprises the steps of:
a) heating the hydrophobic matrix materials to a temperature above the material melting point;
b) dissolving or dispersing the cationic conditioning agents into the melt;
c) dissolving or dispersing the active agents and/or the sensory markers into the melt;
d) dissolving or dispersing the cationic charge boosters in the aqueous phase and heating it to a temperature above the melting point of the melt;
e) mixing the hot melt with the aqueous solution to form a suspension;
f) high shear homogenization of the suspension at a temperature above the melting temperature until a homogeneous fine suspension is obtained; and
g) cooling the suspension to ambient temperature to form a fine dispersion.

In an alternate embodiment, the present invention relates to an improved carrier system for household products, such as cleaning compositions, hard surface cleaning compositions, automatic dishwashing detergent formulations, hand dishwashing detergent formulations, wipe products and deodorizer formulations, comprising particles formed of hydrophobic polymers and copolymers in combination with an active agent, such as a fragrance. The particles can be positively charged. In one embodiment, the composition includes a cationic charge booster to improve fragrance deposition onto a surface. The fragrance carrier system also provides controlled release or prolonged fragrance release from over an extended period of time, or yields a high impact fragrance “burst.”

The fragrance-particle of the present invention can comprise from about 1% to about 95% by weight hydrophobic polymers, hydrophobic copolymers, or a mixture thereof, from about 0.1% to about 10% by weight cationic charge booster and from about 1% to about 50% by weight fragrance. The particles have an average particle size in the range from about 1 micron to about 500 microns and having a melting point in the range from about 60° C. to about 150° C. The particles can be incorporated into any household product.

The carrier system of the present invention can be incorporated in liquid as well as dry granular or powder household compositions and provide long-term storage stability.

It is believed that the highly substantive cationic charge booster in conjunction with the cationic conditioning agents in the spheres surface becomes associated, in use, with hair, skin, fabric and household products and assist in adhering the spheres onto hair, skin, and fabric through both sphere entrainment and electrostatic interactions. The highly cationic charge density of the nano-spheres, achieved by the use of cationic conditioning agents in the solid hydrophobic nano sphere matrix or by using a cationic conditioning agent in the nano sphere solid matrix in conjunction with cationic charge booster in the aqueous phase, improves the deposition of these spheres onto the hair, skin, fabric and household products and prevents them from being washed off during the rinse process. The nano-spheres are believed to attach to the hair and skin surfaces via a complexing interaction between the cationic charge group on the spheres and the proteinaceous portion of the hair, hair follicles or skin and thus predispose or condition the surface of the hair, hair follicle or skin so that the nano-spheres will then adhere to the surface. The hydrophobic matrix materials sustain the diffusion rate of the active ingredients and sensory markers through the spheres and enable the release of the active ingredients and sensory markers over an extended period of time, or during heat treatment such as blow drying the hair or ironing the fabric.

Hair, skin, and fabric treated with hair, skin, and fabric care products, such as to shampoo, conditioners, body wash, detergents and fabric softeners, and the like, comprising the nano-spheres of the present invention were observed to exhibit high level of fragrance (high odor intensity) in both the wet and the dry state and fragrance perception on the dry hair, skin, and fabric has been observed over an extended period of time up to about one month.

The present invention also provides a cost effective controlled delivery system that improves fragrance performance from hair, skin, and fabric care products and household products. The invention still further provides shampoos, conditioners, hair styling products, hair sculpting products, lotions, creams, body wash, liquid laundry detergents, fabric softeners, and other hair, skin, and fabric care products comprising the nano-spheres of the present invention.

The invention will be more fully described by referenced to the following drawings.

### BRIEF DESCRIPTION OF THE DRAWINGS

FIG. 1 is a schematic diagram of a representation of a polyvinyl amine in accordance with the teachings of the present invention.

### DETAILED DESCRIPTION

The present invention features a method of controlling the release rate of fragrance that can be incorporated in a hair, skin, and fabric care products, over an extended period of time, or yields a high impact fragrance “burst” upon heat treatment such as blow drying the hair or ironing the fabric. Heat activation is defined as some change that is mediated by use of the composition of the invention with heat, from styling appliances such as a blow dryer, curling iron, hot curler, hot brush, hot comb, hot rollers, crimper, hair dryer, or iron. From internal testing of various appliances this average temperature can range on the “hot” setting for hair to be between 50° C. to 60° C., whereas that of fabric to be between 80° C. to 90° C. The carrier system of the present invention comprises substantially solid nano-spheres in combination with a cationic conditioning agents or a cationic conditioning agent and a cationic charge booster in the aqueous phase. The term “spheres” is intended to describe solid, substantially spherical particulates. It will be appreciated that other sphere shapes can be formed in accordance with the teachings of the present invention.

The spheres of the present invention have a predetermined sphere size. The low end of the useful size range of the spheres is limited by undue loss of volatile active agents and sensory markers from the sphere. The permeation rate of the active agents and sensory markers from the sphere is proportional to sphere size such that the smaller spheres, the faster the rate that the active agent or sensory marker is being released. The nano-spheres employed herein have an average size (diameter) range of from about 0.01 micron to about 10 microns. Preferably, the sphere size of the spheres is in the range from about 0.01 microns to about 1 micron, and spheres within this range are efficiently entrained on hair. This linear dimension for any individual sphere represents the length of the longest straight line joining two points on the surface of the sphere.

The hydrophobic core of the nano-spheres contains the active ingredients and sensory markers. The active agents and the sensory markers can be either hydrophilic or hydrophobic.

Preferably the nano-spheres have an average sphere size in the range from about 0.01 microns to about 10 microns and have a melting point in the range from about 30° C. to about 100° C. The nano-sphere preferably comprises from about 1% to about 95% by weight hydrophobic polymers, hydrophobic copolymers, waxes, fats, or mixtures thereof, from about 0.01% to about 60% by weight cationic conditioning agents, from about 0.1% to about 70% by weight active agents, and from about 1% to about 70% by weight sensory markers. The aqueous phase can comprise from 0% to 10% by weight cationic charge booster. The nano-spheres can be incorporated into any type of hair, skin, and fabric care products.

A continuous phase of the nano-sphere dispersion formed is aqueous, and can contain the cationic charge booster and additional components such as antioxidants, preservatives, microbicides, buffers, osmoticants, cryoprotectants, and other useful additives or solutes. The additional components are present in an amount from about 1% to about 30% by weight of the aqueous dispersion.

In an alternate embodiment, the present invention relates to a controlled delivery system for use as a household product. Household products include any product used for cleaning, deodorizing or polishing. Some suitable household products include dishwashing detergents, surface cleaners, deodorizers, animal litter and cleaning wipes. Dishwashing detergents can include, for example, automatic dishwashing detergent powders or liquids, and hand dishwashing detergent liquids. Surface cleaners can include, for example, acid hard surface cleaners, basic hard surface cleaners, tile cleaners, glass cleaners, bathroom surface cleaners, furniture polish, carpet powder cleaners, carpet shampoos, automotive cleaners, automotive waxes, automotive polishes and cleaning wipes.

Cleaning wipes can be used for cleaning hard surfaces. Cleaning wipes can comprise single or multiple layers of a material. A wipe product of the present invention comprising multiple layers may be ultrasonically bonded.

The fragrance containing solid particles can be adhered to fibers of single or multiple layers of material. Alternatively, the fragrance containing solid particles can be held between the multiple layers of material. A wide variety of materials can be used as one or more layers of the cleaning wipes. It should have sufficient wet strength, abrasivity, loft and porosity. Examples include nonwoven materials, woven materials, and hydroentangled materials. Some suitable materials for forming the cleaning wipes include cellulose polyester, polypropylene and materials described in U.S. Pat. No. 6,720,301, hereby incorporated by reference into this application. The wipes can be disposable.

I. Cationic Conditioning Agents

The carrier system of the present invention can comprise any of the cationic conditioning agents known in the art. The conditioning agents can include imidazolinium. Other quaternary ammonium salt hair conditioning compounds suitable for use are described in “Cationic Surfactants”, Surfactant Science series, Vol. 34, edited by Richmond J. M., Marcel Dekker Inc., 1990, which are incorporated herein by reference.

Cationic conditioning agents of the present invention, are believed to attach to hair, hair follicle or skin via a complexing interaction between the cationic portion of the cationic conditioning agent and the proteinaceous portion of the hair, hair follicle, skin or fabric and thus predispose or condition the surface of the hair, hair follicle, skin or fabric so that the nano-spheres will then adhere to the surface. Surface active materials that are capable of strong bonding to the negatively charged and hydrophilic surfaces of hair, hair follicle, skin, and fabric include various straight-chain alkylammonium compounds, cyclic alkylammonium compounds, petroleum derived cationics, and polymeric cationic materials. A preferred cationic conditioning agent is Behenamidopropyl hydroxyethyl dimonium chloride and a fatty quaternary ammonium salt, available as Incroquat Behenyl HE, from Croda Inc. Parsippany, N.J.

The cationic conditioning agent can be present in a proportion of about 0.01% to about 70% by weight of the suspension, preferably about 0.1% to about 70% by weight of solid particles.

Ia.) Straight-chain Alkylammonium Compounds

One group of cationic conditioning agents useful for enhancing the deposition of the nano-spheres of the present invention onto hair, hair follicle, skin or fabric are quaternary ammonium compounds. Quaternary ammonium salts useful herein also include dialkyldimethylammonium chlorides wherein the alkyl groups have from 12 to 22 carbon atoms. The alkyl groups can be derived from long-chain fatty acids, such as hydrogenated tallow fatty acid. Tallow fatty acid gives rise to quaternary compounds wherein the substituted groups contain predominantly from 16 to 22 carbon atoms. Examples include ditallow dimethyl ammonium chloride, ditallow dimethyl ammonium methyl sulfate, dihexadecyl dimethyl ammonium chloride, di(hydrogenated tallow)dimethyl ammonium chloride, dioctadecyl dimethyl ammonium chloride, dieicosyl dimethyl ammonium chloride, didocosyl dimethyl ammonium chloride, di(hydrogenated tallow)dimethyl ammonium acetate, dihexadecyl dimethyl ammonium chloride, dihexadecyl dimethyl ammonium acetate, ditallow dipropyl ammonium phosphate, ditallow dimethyl ammonium nitrate, di(coconutalkyl)dimethyl ammonium chloride, and stearyl dimethyl benzyl ammonium chloride. Preferred quaternary ammonium salts useful herein include ditallow dimethyl ammonium chloride, dicetyl dimethyl ammonium chloride, stearyl dimethyl benzyl ammonium chloride, cetyl trimethyl ammonium chloride, tricetyl methyl ammonium chloride, and mixtures thereof.

Di(hydrogenated tallow)dimethyl ammonium chloride (Quaternium-18) is a particularly preferred quaternary ammonium salt, and is available from the Sherex Chemical Company, Inc. as Adogen® 442 and Adogen® 442-100P.

Salts of primary, secondary and tertiary fatty amines can also be used as cationic conditioning agents. The alkyl groups of such amines preferably have from 12 to 22 carbon atoms, and can be substituted or unsubstituted. Secondary and tertiary amines are preferred; and tertiary amines are particularly preferred. Examples of useful amines include stearamido propyl dimethyl amine, diethyl amino ethyl stearamine, dimethyl stearamine, dimethyl soyamine, soyamine, myristyl amine, tridecyl amine, ethyl stearylamine, N-tallowpropane diamine, ethoxylated (5 moles E.O.) stearylamine, dihydroxy ethyl stearylamine, and arachidylbehenylamine. Suitable amine salts include the halogen, acetate, phosphate, nitrate, citrate, lactate and alkyl sulfate salts. Examples include stearylamine hydrochloride, soyamine chloride, stearylamine formate, N-tallow propane diamine dichloride and stearamidopropyl dimethylamine citrate.

Suitable conditioning agents are quaternary ammonium salts. Quaternary ammonium salts include dialkyldimethylammonium chlorides, wherein the alkyl groups have from 12 to 22 carbon atoms. These alkyl groups may be derived from long-chain fatty acids, such as hydrogenated tallow fatty acid. Tallow fatty acid gives rise to quaternary compounds wherein the substituted groups predominantly contain from 16 to 18 carbon atoms. Examples of quaternary ammonium salts include: di(hydrogenated)tallow dimethyl ammonium chloride; dicetyl dimethyl ammonium chloride; tricetyl methyl ammonium chloride; cetyl trimethyl ammonium chloride; stearyl dimethyl benzyl ammonium chloride; and mixtures thereof. Most preferred is dicetyl dimethyl ammonium chloride.

Other suitable conditioning agents are: behenalkonium chloride; behentrimonium chloride; behenalkonium methosulfate; behentrimonium methosulfate; behenamidopropylamine oxide; behenopropyl dimethylamine; behenamidopropyl dimethylamine; behenamidopropyl dimethylamine behenate; behenamidopropyl ethyldimonium ethosulfate; behenamidopropyl PG-dimonium chloride; behenamine; and behenamidopropyl hydroxyethyl dimonium chloride.

Ib.) Cyclic Alkylammonium Compounds

Another preferred group of compounds of cationic conditioning agents useful for enhancing deposition of nano-spheres onto the hair, hair follicles, skin, and fabric include a class of surface-active quaternary ammonium compounds in which the nitrogen atom carrying the cationic charge is part of a heterocyclic ring. Suitable compounds, for example, are as follows: laurylpyridinium chloride or bromide; tetradecylpyridinium bromide; and cetylpyridinium halide, wherein the halide is chloride, bromide or fluoride.

Ic.) Petroleum Derived Cationic Compounds

Typical basic amines useful for the present invention are derived from petroleum-based raw materials such as olefins, paraffins, and aromatic hydrocarbons and include compounds with at least one aliphatic carbon chain containing six or more carbon atoms attached to the nitrogen. Amine salts, diamines, amidoamines, alkoxylated amines, and their respective quaternary salts are suitable for the present invention. Suitable compounds of this type include tallow or coco alkyl substituted 1,3-propylene diamines sold by Witco under the names of “Adogen” and “Emcol” and similar diamines sold by Akzo under the name “Duomeen” and polyethenoxy derivatives sold by Akzo under the names of “Ethomeen” and “Ethoduomeens”.

Id.) Cationic Polymers

Cationic polymers suitable for use in the present invention are selected from the group of polyquaternium 32, polyquaternium 3, cocodimonium hydroxypropyl hydrolyzed collagen, cocodimonium hydroxypropyl hydrolyzed hair keratin, cocodimonium hydroxypropyl hydrolyzed hair keratin, cocodimonium hydroxypropyl hydrolyzed keratin, cocodimonium hydroxypropyl hydrolyzed wheat protein, cocodimonium hydroxypropyl oxyethyl cellulose, guar hydroxypropyltrimonium chloride, lauryldimonium hydroxypropyl hydrolyzed collagen, lauryldimonium hydroxypropyl hydrolyzed wheat protein, lauryldimonium hydroxypropyl oxyethyl cellulose, polyquaternium 4, polyquaternium 10, polyquaternium 24, steardimonium hydroxyethyl cellulose, steardimonium hydroxypropyl hydrolyzed collagen, steardimonium hydroxypropyl hydrolyzed wheat protein, steardimonium hydroxypropyl oxyethyl cellulose, steardimonium hydroxyethyl hydrolyzed collagen, polymethacrylamidopropyl trimonium chloride, polyquaternium 2, polyquaternium 6, polyquaternium 7, polyquaternium 11, polyquaternium 16, polyquaternium 17, polyquaternium 18, polyquaternium 22, polyquaterium 24, polyquaternium 27, polyquaternium 28, polyquaternium 31, polyquaternium 39, polyquaternium 41, polyquaternium 42, quaternium 80, and quaternized hydrolyzed wheatiprotein/dimethicone phosphocopolyol copolymer. The preferred cationic conditioning agent are polyquaterium-24 available under the name Quatrisoft® polymer LM-200, from Amerchol Corporation.

Also suitable, for the purpose of this invention, are cationic derivatives of polysaccharides such as dextran, starch or cellulose, for example, diethylaminoethyl cellulose (“DEAE-cellulose”). Further examples of suitable materials are the cationic guar derivatives such as those sold under the trade name JAGUAR® by Celanese-Hall.

A further preferred group of compounds, which comprises a class of water-insoluble polymers, having nitrogen atoms in their molecules, are quaternary polymers of quaternary ammonium type, betaine type, pyridylpyridinium type or vinylpyridinium-type. Examples are as follows poly(vinyl-benzylmethyllaurylammonium chloride); poly(vinyl-benzylstearylbetaine); poly(vinyl-benzyllaurylpyridylpyridinium chloride); poly(vinyl-benzylcetylammonylhexyl ether) and quaternized polyoxyethyleneated long chain amines, with the general formula RN(CH₃)[(C₂H₄O)ₓH]₂(+)A(−), where A(−) is generally chloride or fluoride, x is a number from 1 to 20, and R is C₈₋₂₂-alkyl.

In a preferred embodiment, the cationic conditioning agent is a preferred cationic conditioning agent is behenamidopropyl hydroxyethyl dimonium chloride and a fatty quaternary ammonium salt, available as Incroquat Behenyl HE, from Croda Inc. Parsippany, N.J.: The cationic conditioning agent can be present in a proportion of about 0.01% to about 70% by weight of the suspension, preferably about 0.1% to about 70% by weight.

II. Cationic Charge Boosters

The controlled delivery system of the present invention may comprises a cationic charge booster in the aqueous phase of the dispersion. Suitable cationic charge boosters are described in U.S. Pat. No. 6,083,899 hereby incorporated by reference into this application. The preferred cationic charge boosters of the present invention are described herein below.

IIa. Quaternary Ammonium Compounds

A preferred composition of the present invention comprises preferably from about 0% to about 10%, more preferably from about 0% to about 5% by weight, of a cationic charge booster having the formula: 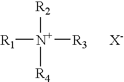
wherein R₁, R₂, R₃, and R₄ are each independently C₁-C₂₂ alkyl, C₃-C₂₂ alkenyl, R₅-Q-(CH₂)ₘ—, wherein R₅ is C₁-C₂₂ alkyl, and mixtures thereof, m is from 1 to about 6; X is an anion. Preferably R₁ is C₆-C₂₂ alkyl, C₆-C₂₂ alkenyl, and mixtures thereof, more preferably R₁ C₁₁-C₁₈ alkyl, C₁₁-C₁₈ alkenyl, and mixtures thereof, R₂, R₃, and R₄ are each preferably C₁-C₄ alkyl, more preferably each R₂, R₃, and R₄ are methyl.

Alternatively, R₁ can be a R₅-Q-(CH₂)ₘ— moiety wherein R₅ is an alkyl or alkenyl moiety having from 1 to 22 carbon atoms, preferably the alkyl or alkenyl moiety when taken together with the Q unit is an acyl unit. For example Q can be derived from a source of triglyceride selected from tallow, partially hydrogenated tallow, lard, partially hydrogenated lard, vegetable oils, partially hydrogenated vegetable oils, such as canola oil, safflower oil, peanut oil, sunflower oil, corn oil, soybean oil, tall oil, rice bran oil, and the like and mixtures thereof.

An example of a cationic charge booster comprising a R₅-Q-(CH₂)ₘ— moiety has the formula: 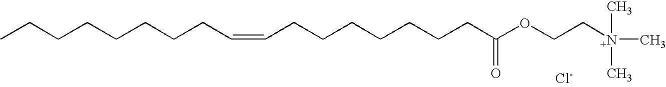
wherein R₅-Q- represents oleoyl units and m is equal to 2.

Preferably X is a softener compatible anion, such as the anion of a strong acid. For example, X can be chloride, bromide, methylsulfate, ethylsulfate, sulfate, nitrate and mixtures thereof. More preferably X is chloride and methyl sulfate.

IIb. Polyvinyl Amines

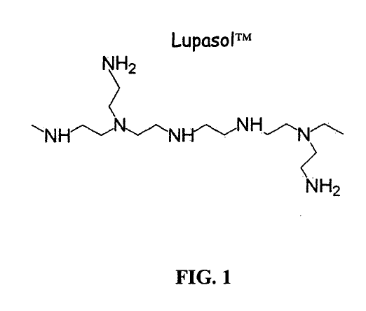

A preferred composition according to the present invention contains from about 0% to about 10%, more preferably from about 0% to about 5% by weight, of one or more polyvinyl amines charge boosters having the formula 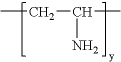
wherein y is from about 3 to about 10,000, preferably from about 10 to about 5,000, more preferably from about 20 to about 500. Polyvinyl amines suitable for use in the present invention are available from BASF under the name Lupasol® LU 321. Lupasol™ has very strong affinity for anions and polar materials and has very good binding properties; ionic bonding 10-30 Kcal/mol, hydrogen bonding 4-6 Kcal/mol, van der Waals bonding 0.5-2 Kcal/mol. An example of the polyvinyl amine referred to as Lupasol™ is shown in FIG. 1. The greater number of amine moieties per unit weight on the polyvinyl amines provides preferred substantial charge density.
IIc. Polyalkyleneimines

A preferred composition of the present invention comprises from about 0% to about 10%, more preferably from about 0% to about 5% by weight, of a polyalkyleneimine charge booster having the formula: 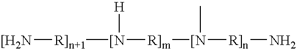
wherein the value of m is from 2 to about 700 and the value of n is from 0 to about 350.

Preferably the compounds of the present invention comprise polyamines having a ratio of m:n that is at least 1:1 but may include linear polymers (n equal to 0) as well as a range as high as 10:1, preferably the ratio is 2:1. When the ratio of m:n is 2:1, the ratio of primary:secondary:tertary amine moieties of —RNH₂, —RNH, and —RN moieties, is 1:2:1. R can be C₂-C₈ alkylene, C₃-C₈ alkyl substituted alkylene, and mixtures thereof. Preferably R is ethylene, 1,2-propylene, 1,3-propylene, and mixtures thereof, and more preferably ethylene. R radicals serve to connect the amine nitrogens of the backbone.

Optionally, one or more of the polyvinyl amine backbone —NH₂ unit hydrogens can be substituted by an alkyleneoxy unit having the formula:
—(R₁O)ₓR₂
wherein R₁ is C₂-C₄ alkylene; R₂ is hydrogen, C₁-C₄ alkyl, and mixtures thereof; and x is from 1 to 50. In one embodiment or the present invention the polyvinyl amine is reacted first with a substrate which places a 2-propyleneoxy unit directly on the nitrogen followed by reaction of one or more moles of ethylene oxide to form a unit having the general formula: 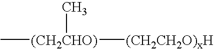
wherein x has the value of from 1 to about 50. Substitutions such as the above are represented by the abbreviated formula PO-EO—. However, more than one propyleneoxy unit can be incorporated into the alkyleneoxy substituent.

The preferred polyamine cationic charge boosters of the present invention comprise backbones wherein less than about 50% of the R groups comprise more than 3 carbon atoms. The use of two and three carbon spacers as R moieties between nitrogen atoms in the backbone is advantageous for controlling the charge booster properties of the molecules. More preferred embodiments of the present invention comprise less than about 25% moieties having more than 3 carbon atoms. Yet more preferred backbones comprise less than about 10% moieties having more than 3 carbon atoms. Most preferred backbones comprise about 100% ethylene moieties.

The cationic charge boosting polyamines of the present invention comprise homogeneous or non-homogeneous polyamine backbones, preferably homogeneous backbones. For the purpose of the present invention the term “homogeneous polyamine backbone” is defined as a polyamine backbone having R units that are the same such as, all ethylene. However, this definition does not exclude polyamines that comprise other extraneous units comprising the polymer backbone that are present due to an artifact of the chosen method of chemical synthesis. For example, it is known to those skilled in the art that ethanolamine may be used as an “initiator” in the synthesis of polyethyleneimines, therefore a sample of polyethyleneimine that comprises one hydroxyethyl moiety resulting from the polymerization “initiator” would be considered to comprise a homogeneous polyamine backbone for the purposes of the present invention.

For the purposes of the present invention the term “non-homogeneous polymer backbone” refers to polyamine backbones that are a composite of one or more alkylene or substituted alkylene moieties, for example, ethylene and 1,2-propylene units taken together as R units.

However, not all of the suitable charge booster agents belonging to this category of polyamine comprise the above described polyamines. Other polyamines that comprise the backbone of the compounds of the present invention are generally polyalkyleneamines (PAAs), polyalkyleneimines (PAIs), preferably polyethyleneamine (PEAs), or polyethyleneimines (PEIs). Polyethyleneimines suitable for use in the present invention are available from BASF under the trade name Lupasol® such as Lupasol™ PR8515, having an average molecular weight of 1,800, Lupasol™ Waterfree; Lupasol™ P, Lupasol™ PR971L; Lupasol™ PL; Lupasol™ SKA. Ethoxylated polyethyleneimines suitable for use in the present invention are available from BASF under the name Lupasol™ SC®-61B. A common polyalkyleneamine (PAA) is tetrabutylenepentamine. PEA's can be obtained by reactions involving ammonia and ethylene dichloride, followed by fractional distillation. The common PEAs obtained are triethylenetetramine (TETA) and tetraethylenepentamine (TEPA). Above the pentamines, such as, the hexamines, heptamines, octamines and possibly nonamines, the cogenerically derived mixture does not appear to separate by distillation and can include other materials such as cyclic amines and particularly piperazines.

IId. Poly-Quaternary Ammonium Compounds

A preferred composition of the present invention comprises from about 0% to about 10%, more preferably from about 0% to about 5% by weight, of a cationic charge booster having the formula: 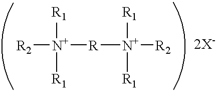
wherein R is substituted or unsubstituted C₂-C₁₂ alkylene, substituted or unsubstituted C₂-C₁₂ hydroxyalkylene; each R₁ is independently C₁-C₄ alkyl, each R₂ is independently C₁-C₂₂ alkyl, C₃-C₂₂ alkenyl, R₅-Q-(CH₂)ₘ—, wherein R₅ is C₁-C₂₂ alkyl, C₃-C₂₂ alkenyl, and mixtures thereof; m is from 1 to about 6; Q is a carbonyl unit as described above and mixtures thereof; X is an anion.

Preferably R is ethylene and R₁ is preferably methyl or ethyl, more preferably methyl. Preferably at least one R₂ is C₁-C₄ alkyl, more preferably methyl. Most preferably at least one R₂ is C₁₁-C₂₂ alkyl, C₁₁-C₂₂ alkenyl, and mixtures thereof.

Alternatively R₂ is a R₅-Q-(CH₂)ₘ— moiety wherein R₅ is an alkyl moiety having from 1 to 22 carbon atoms, preferably the alkyl moiety when taken together with the Q unit is an acyl unit derived from a source of triglyceride selected from the group consisting of tallow, partially hydrogenated tallow, lard, partially hydrogenated lard, vegetable oils, partially hydrogenated vegetable oils, such as, canola oil, safflower oil, peanut oil, sunflower oil, corn oil, soybean oil, tall oil, rice bran oil, and the like and mixtures thereof.

An example of a fabric softener cationic booster comprising a R₅-Q-(CH₂)ₘ— moiety has the formula: 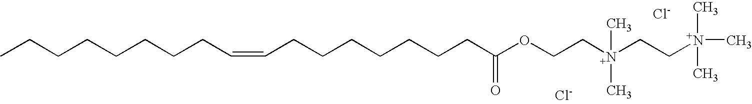
wherein R₁ is methyl, one of the R₂ units is methyl and the other of the R₂ unit is R₅-Q-(CH₂)ₘ— wherein R₅-Q- is an oleoyl unit and m is equal to 2. X is a softener compatible anion, such as an anion of a strong acid. For example, X can be chloride, bromide, methylsulfate, ethylsulfate, sulfate, nitrate and mixtures thereof. More preferably chloride and methyl sulfate.
III. Matrix Materials

The matrix materials for forming the spheres of the carrier system of the present invention comprise any substantially water-insoluble polymers, copolymers, waxes, fats, and mixtures thereof with a melting point range between about 30° C. and about 100° C., that are compatible with and miscible with the active agents or sensory markers composition used in the present invention and harmless or beneficial to the hair, hair follicles, skin, and fabric when dispersed and melted on to them.

Examples of hydrophobic materials include natural, regenerated, or synthetic waxes including animal waxes such as beeswax, lanolin and shellac wax, vegetable waxes such as carnauba, candelilla, sugar cane, rice bran, and bayberry wax, mineral waxes such as petroleum waxes including paraffin and microcrystalline wax, and mixtures thereof. Other hydrophobic materials which can be used in the present invention include wax and silicon copolymers, such as candelilla wax and silicone copolymer, ozokrite wax and silicon copolymers, beeswax and silicon copolymers, and the like. Other hydrophobic compounds which can be used in the present invention include: fatty acid esters such as ethyl stearate, isopropyl myristate, and isopropyl palmitate; high molecular weight fatty alcohols such as cetostearyl alcohol, cetyl alcohol, stearyl alcohol, and oleyl alcohol, solid hydrogenated castor and vegetable oils, hard paraffins, hard fats, and mixtures thereof. Other hydrophobic compounds which can be used, include triglycerides, preferably of at least food grade purity, which can be produced by synthesis or by isolation from natural sources. Natural sources can include animal fat or vegetable oil, such as soy oil, as a source of long chain triglycerides (LCT). Other triglycerides suitable for use in the present invention are composed of a majority of medium length fatty acids (C10-C18), denoted medium chain triglycerides (MCT). The fatty acid moieties of such triglycerides can be unsaturated or polyunsaturated and mixtures of triglycerides having various fatty acid material. The nano sphere matrix can comprise a single hydrophobic material or a mixture of a plurality of materials. Other hydrophobic materials that are known to those skilled in the art and suitable materials as described in “Industrial Waxes,” Vol. I and II, by Bennett F. A. I. C., published by Chemical Publishing Company Inc., 1975 and Martindale, “The Extra Pharmacopoeia”, The Pharmaceutical Press, 28^{th}. Edition pp. 1063-1072, 1982 can be used in the present invention.

Other hydrophobic compounds which can be used in the present invention include synthetic polymers, such as alkylated polyvinylpyrrolidines, the Ganex® copolymer series, and ProLipids® 151 (commercially available from the ISP Company), Purester® series of materials (especially Purester® 24 and Purester 34, vegetable derived esters 5 produced from naturally derived fatty alcohol & methyl ester feedstocks which are non-GMO vegetable based renewable resources, commercially available from Strahl & Pitsch Inc. of West Babylon, N.Y.).

Examples of other suitable hydrophobic polymers and copolymer for use as the matrix material include polyethylene homopolymers A-C® 1702; A-C® 617, A-C® 617A, and A-C® 15, commercially available from Allied Signal Inc.; PERFORMALENE™ polyethylene homopolymer series commercially available from New Phase Technologies; PERFORMACOL™ linear primary alcohols series commercially available from New Phase Technologies; PERFORMACID™ linear saturated carboxylic acid series commercially available from New Phase Technologies; PERFORMA V™ polymer series commercially available from New Phase Technologies; ETHYLENE-ACRYLIC ACID COPOLYMERS A-C® 540, A-C® 540A, and A-C® 580 commercially available from Allied Signal Inc.; polyamides having a molecular weight in the range of from about 6,000 up to about 12,000, for example, MACROMELT™ 6030 manufactured by the Henkel Ag. of Dusseldorf, Germany; VERSALON™ 1135 polyamide polymer available commercially from General Mills, Inc.

It is preferred that the nano-spheres of the present invention have a melting point in the range from about 30° C. to about 100° C., preferably from about 40° C. to about 90° C. The melting point of the spheres is usually a function of the carrier matrix employed. Accordingly, preferred matrix materials have a melting point in the range of about 40° C. to about 80° C., preferably from about 50° C. to about 70° C. It should be understood that it is the melting point of the sphere rather than of the carrier matrix that is important for use of the carrier system of the present invention.

Considerations in the selection of the matrix material include good barrier properties to the active agents and the fragrance ingredients, low toxicity and irritancy, stability, and high loading capacity for the active agents of interest.

V. Active Agents

The active agents can be cosmetic, dermatological, and pharmaceutical active agents. Suitable active agents include ceramides, vitamins, antioxidants, free radical scavengers, moisturizing agents, anti-seborrhoeic agents, anti-UV agents, keratolytic agents, anti-inflammatory agents, refreshing agents, melanoregulators, liporegulators, antiseborrhoeic agents, anti-ageing agents, keratolytic agents, antibacterial agents, anti-dandruff agents, agents for combating hair loss, hair dyes, hair bleaches, reducing agents for permanent waves, hair conditioners and nutrients, cicatrizing agents, vascular protectors, antibacterial agents, anti fungal agents, skin conditioners, immunomodulators, nutrients and essential oils, retinoids, anesthetics, surfactants, emulsifiers, stabilizers, preservatives, antiseptics, emollients, lubricants, humectants, analgesics, enzymes, pigments, dyes, hydroxy acids, such as, alpha hydroxy acids, and beta hydroxy acids, emollients, medications, antibiotics, repellants, attractants such as, pheromones, fragrances, sensory markers such as cooling agents of menthol derivatives, hyaluronic acid and its salts, elastin, hydrolysates, primrose oil, jojoba oil, epidermal growth factor, soybean saponins, mucopolysaccharides, ironing aids such as silicones; anti-shrinkage agents; anti-wrinkle agents; bleaching agents, fabric crisping agents; spotting agents; germicides; fungicides; stabilizers preservatives; bactericides which can be effective to protect the composition or to treat fabrics; and mixtures thereof. The fragrance can have a calculated IogP (ClogP) in the range of about 1 to about 8.

Drugs

Suitable drugs which can be administered in the delivery system of the present invention include but are in no way limited to anti-bacterial agents such as thimerosal, chloramine, boric acid, phenol, iodoform, chlorhexidine and other oral antiseptics, beta-lactam antibiotics, for example cefoxitin, n-formamidoyl thienamycin and other thienamycin derivatives, tetracyclines, chloramphenicol, neomycin, gramicidin, kanamycin, amikacin, sismicin and tobramycin; anti-inflammatory steroids such as cortisone, hydrocortisone, beta-methasone, dexamethasone, fluocortolone, prednisolone, triamcinolone and the like. The biologically active ingredient my also be one or more antibiotics, such as penicillin, polymyxin B, vancomycin, kanamycin, erythromycin, niddamycin, metronidazole, spiramycin and tetracycline.

Sensory Markers

The present invention can include sensory markers such as fragrances and cooling agents such as menthol derivatives. Preferably the sensory markers are synchronized with the release of the active agents to convey to the consumer the product performance, provide long lasting odor and signal that a new application of the product is needed.

The fragrance ingredients and compositions of this invention can be conventional ones known in the art. Selection of any perfume component, or amount of perfume, is based on functional and aesthetic considerations. Typical examples of usable fragrance and flavor compounds discussed hereinafter, along with their odor characters, and their physical and chemical properties, are described in “Perfume and Flavor Chemicals (Aroma Chemicals)”, Steffen Arctander, published by the author, 1969, and in “Common Fragrance and flavor Materials—Preparation, Properties and Uses”, Kurt Bauer and Dorotea Garbe, published by VCH Verlagsgesellschaft mbH, 1985, incorporated herein as reference.

Preservatives

Preservatives can be incorporated into the present invention to protect against the growth of potentially harmful microorganisms. While it is in the aqueous phase that microorganisms tend to grow, microorganisms can also reside in the anhydrous or oil phase. As such, preservatives, which have solubility in both water and oil, are preferably employed in the present compositions. Suitable traditional preservatives for compositions of this invention are alkyl esters of parahydroxybenzoic acid. Other preservatives, which can be used include hydantoin derivatives, propionate salts, and a variety of quaternary ammonium compounds.

Particularly preferred preservatives are methylparaben, imidazolidinyl urea, sodium dehydroacetate, propylparaben, trisodium ethylenediamine tetraacetate (EDTA), and benzyl alcohol. The preservative can be selected to avoid possible incompatibilities between the preservative and other ingredients. Preservatives are preferably employed in amounts ranging from about 0.01% to about 2% by weight of the composition. Other preservatives known in the art can be used in the present invention.

VI. Processing Method

The sphere-making procedures described generally in Nixon (ed.), Microencapsulation, pp. 13-38 (Marcel Dekker, Inc. 1976); Muller, Colloidal Carriers for Controlled Drug Delivery and Targeting, pp. 175-202 (CRC Press 1991); Shaw (ed.), Lipoproteins as Carriers of Pharmacological Agents, pp. 97-139 (Marcel Defter, Inc. 1991); and Benita (ed.), Microencapsulation—Methods and Industrial applications, pp. 183-258 (Marcel Defter, Inc. 1996).

The process for producing the nano-spheres comprises the steps of:
a) heating the hydrophobic matrix materials to a temperature above the material melting point;
b) dissolving or dispersing the cationic conditioning agents into the melt;
c) dissolving or dispersing the active agents and/or the sensory markers into the melt;
d) dissolving or dispersing the cationic charge boosters in the aqueous phase and heating it to a temperature above the melting point of the melt;
e) mixing the hot melt with the aqueous solution to form a suspension;
f) high shear homogenization of the suspension at a temperature above the melting 30 temperature until a homogeneous fine suspension is obtained; and
g) cooling the suspension to ambient temperature to form a fine dispersion.

The melt phase is dispersed into the aqueous phase by agitation, such as with an ultrasonic processor, high pressure homogenizer, colloid mill, or high sheer mixer until small, fairly uniform size spheres are formed. The dispersion is then cooled to at least room temperature to form the final suspension of hydrophobic phase spheres within the continuous aqueous phase.

The fairly uniform spheres formed within the aqueous phase should be less than about 2 microns, preferably have number average diameters of less than about 1 micron, more preferably have number average diameters of less than about 0.5 microns, and most preferably have number average diameters of between about 0.01 and about 0.5 microns, with about 0.1 to about 1 microns being particularly preferred.

The method of preparation of nano-spheres described herein is simple and is characterized by high loading, reproducibility, versatility, and stability. The method is further illustrated in the non-limiting examples.

The active agents and sensory markers that are dissolved within in the nano-spheres can be released by molecular diffusion at a rate according to Fick's second law of diffusion described in “Diffusion in Polymers”, Crank J. and Park G. S., Academic Press, New-York, 1969; “Barriers Polymers and Structures”, Edited by Koros W. J., ACS Series, Washington D.C., 1990; “Polymer Permeability”, Edited by J. Comyn, Elsevier Applied Science publishers, 1985 pp. 217-267; incorporated herein as references:

$$\frac{\partial C}{\partial t} = \frac{\partial }{\partial X} ( D \frac{\partial C}{\partial X} ) = D \frac{{\partial }^{2} C}{\partial {X}^{2}}$$

where:
D=diffusion coefficient
C=concentration of the diffusing
molecule X=direction of diffusion
t=time

Higuchi has developed equations for spherical monolithic devices having homogenous matrices (Higuchi T., J. Pharm. Sci., 52, 1145, 1963). The theoretical early and late time approximation of the release rate of the active ingredients dissolved in the hydrophobic matrix of the nano spheres can be calculated from the following equations:

Early Time Approximation

$$( {m}_{t} / {m}_{∞} ) < 0.4$$

$$\frac{{M}_{t}}{{M}_{∞}} = {6 [ \frac{Dt}{{r}^{2} π} ]}^{1 / 2} - \frac{3 Dt}{{r}^{2}}$$

Late Time Approximation

$$( {m}_{t} / {m}_{∞} ) < 0.6$$

$$\frac{{M}_{t}}{{M}_{∞}} = 1 - \frac{6}{{π}^{2}} exp [ \frac{- {π}^{2} Dt}{{r}^{2}} ]$$

Where;
r—the radius of the cylinder
m_{∞}—the amount of active released from the controlled release system after infinite time
mₜ—the amount of active released from the controlled release system after time t
D—the diffusion coefficient of the fragrance or aroma chemical in the polymer

Brophy and Deasy (Brophy M. and Deasy p. B., Int. J. Pharm., 37, 41, 1987) developed an equation based on the pseudo steady state approximation of Higuchi. The equation derived describes the release of a dispersed solute from a rigid sphere matrix where there is no swelling or erosion of the matrix.

$${M}_{t} = {A [ DCs ( 2 Co - Cs ) t ]}^{1 / 2} - \frac{4}{9} 8 π r DCs \frac{3 Co - 2 Cs}{2 Co - Cs} t$$

Where:
Co is active concentration in the microspheres
Cs is the active solubility (the saturation concentration)
r is the radius of the sphere

The invention can be further illustrated by the following examples thereof, although it will be understood that these examples are included merely for purposes of illustration and are not intended to limit the scope of the invention unless otherwise specifically indicated. All percentages, ratios, and parts herein, in the Specification, Examples, and claims, are by weight and are approximations unless otherwise stated.

### Preparation of Nano Spheres Fragrance Delivery Systems

### EXAMPLE 1

The fragrance used in the following examples 1-8 is a fragrance composition that is not substantive on hair when used as neat oil. The fragrance composition used is as follows:

| Perfume Composition | Component (% Wt.) |
|---|---|
| Geraniol | 30.0 |
| Dihydro Myrcenol | 20.0 |
| Phenyl Ethyl Alcohol | 5.0 |
| Linalool | 25.0 |
| Tetrahydro Linalyl Acetate | 20.0 |

The nano-spheres had the following composition; Incroquat Behenyl HE, behenamidopropyl hydroxyethyl dimonium chloride (a fatty quaternary ammonium salt, commercially available from Croda) was used as cationic conditioning agent and LUPASOL™ PR815, a polyethyleneimine having an average molecular weight of 1800 (commercially available from BASF Corporation) was used as a cationic charge booster. The hydrophobic polymer was candelilla/silicon copolymer (commercially available from Strahl & Pitsch Inc.) The suspension is homogenized using an APV, Rannie 2000 high pressure homogenizer. The resulting formulation is:
64.9% water
20% candelilla/silicon copolymer
10% Fragrance
5% Incroquat
Behenyl HE 0.1%
LUPASOL™
PR815
200 grams of candelilla/silicon copolymer is placed in an oven at 120° C. and allowed to melt. 649 grams of deionized water is placed into one gallon vessel of the homogenizer, that fitted with an all-purpose silicon rubber heater (Cole-Palmer Instrument Company). 1 gram of LUPASOL™ PR815 is added to the water and the aqueous solution is heated to 90° C. while mixing it with a propeller mixer. The candelilla/silicon copolymer melt is removed from the oven, 50 grams of Incroquat 25 Behenyl HE and 100 grams fragrance are mixed into the candelilla/silicon copolymer melt by hand with a glass rod. The melt mixture is than poured into the vessel containing aqueous solution and the emulsion is homogenized at 20,000 psi. The dispersion is cooled to ambient temperature by passing it through a tube-in-tube heat exchanger (Model 00413, Exergy Inc. Hanson Mass.).

### EXAMPLE 2

The nano-spheres had the following composition; Incroquat Behenyl HE, behenamidopropyl hydroxyethyl dimonium chloride (a fatty quaternary ammonium salt, commercially available from Croda) was used as cationic conditioning agent. The hydrophobic polymer was polyethylene homo-polymer (commercially available from New Phase Technologies.) The suspension is homogenized using an APV, Rannie 2000 High Pressure Homogenizer. The resulting formulation is:
60% water;
10% fragrance;
10% Incroquat
Behenyl HE 20%
polyethylene
200 grams of polyethylene polymer is placed in an oven at 120° C. and allowed to melt. 600 grams of deionized water is placed into one gallon vessel of the homogenizer, that fitted with an all-purpose silicon rubber heater (Cole-Palmer Instrument Company). The water and the aqueous solution is heated to 95° C. The polyethylene polymer is removed from the oven, 100 grams of Incroquat Behenyl HE and 100 grams of fragrance are mixed into the polyethylene polymer by hand with a glass rod. The melt mixture is than poured into the vessel containing water and the emulsion is homogenized at 20,000 psi. The dispersion is cooled to ambient temperature by passing it through a tube-in-tube heat exchanger (Model 00413, Exergy Inc. Hanson Mass.).

### Preparation of Nano Spheres Delivery Systems for Skin

### EXAMPLE 3

The nano-spheres had the following composition; Incroquat Behenyl HE, behenamidopropyl hydroxyethyl dimonium chloride (a fatty quaternary ammonium salt, commercially available from Croda) was used as cationic conditioning agent. The hydrophobic polymer was polyethylene homo-polymer, PERFORMA V™ 216 (commercially available from New Phase Technologies.) The suspension is homogenized using an APV, Rannie 2000 High Pressure Homogenizer. The resulting formulation is:
60% water;
10% Retinol (commercially available from BASF)
10% Incroquat Behenyl HE 20% PERFORMA V™ 216
200 grams of polyethylene polymer is placed in an oven at 120° C. and allowed to melt. 600 grams of deionized water is placed into one gallon vessel of the homogenizer, that fitted with an all-purpose silicon rubber heater (Cole-Palmer Instrument Company). The water and the aqueous solution is heated to 95° C. The polyethylene polymer is removed from the oven, 100 grams of Incroquat Behenyl HE and
100 grams of Retinol are mixed into the polyethylene polymer by hand with a glass rod. The melt mixture is than poured into the vessel containing water and the emulsion is homogenized at 20,000 psi. The dispersion is cooled to ambient temperature by passing it through a tube-in-tube heat exchanger (Model 00413, Exergy Inc. Hanson Mass.).

### EXAMPLE 4

The nano-spheres had the following composition; incroquat behenyl HE, behenamidopropyl hydroxyethyl dimonium chloride (a fatty quaternary ammonium salt, commercially available from Croda) was used as cationic conditioning agent. The hydrophobic polymer was polyethylene homo-polymer (commercially available from New Phase Technologies.) The suspension is homogenized using an APV, Rannie 2000 high pressure homogenizer. The resulting formulation is:
65% water; 10% Vitamin E
5% Incroquat Behenyl HE 20% Ganex V™ 660
200 grams of Ganex V™ 660 polymer is placed in an oven at 100° C. and allowed to melt. 650 grams of deionized water is placed into one gallon vessel of the homogenizer, that fitted with an all-purpose silicon rubber heater (Cole-Palmer Instrument Company). The water and the aqueous solution is heated to 95° C. The polyethylene polymer is removed from the oven, 50 grams of incroquat behenyl HE and 100 grams vitamin E are mixed into the Ganex V™ 660 polymer by hand with a glass rod. The melt mixture is than poured into the vessel containing water and the emulsion is homogenized at 20,000 psi. The dispersion is cooled to ambient temperature by passing it through a tube-in-tube heat exchanger (Model 00413, Exergy Inc. Hanson Mass.).
   Test Methods for Fabric Care Products

Twenty cotton towels having the following dimensions 14″×17″ were used for evaluating the performance of the fragrance carrier spheres of the present invention. Ten of the towels were 100% cotton and ten were composed of a mixture of 65% polyester and 35% cotton. The fabric was laundered in an American washing machine Kenmore™ 90 series.

Wash Conditions:
Fabric Load: 20 towels
Laundry detergent sample size: 100 grams
Fabric softener sample size: 30 grams
Dosing into the machine: Laundry detergent was dosed directly into the machine
Fabric softener was placed in the dispenser
Water level: Small Load
Water temperature: Cold/Cold
Cycle: Short cycle
Water temperature: Cold/Cold Rinse options: One rinse cycle Speeds: Heavy duty

The laundered fabric was line dried overnight in a fragrance free room. The dry fabric was folded into two and placed into an aluminum tray, approximately 5 cm deep, covered with a perforated aluminum sheet, in order to keep it out of view, up to the moment of the sniff-test. The sniff-test was performed on the dry laundered fabric in a “pre-ventilated” room by ten graders, 24 hours following wash. The laundered fabric was then covered with a perforated aluminum sheet, and was evaluated again after one week and two weeks by a sniff-test method.

Odor perception is, by its nature, a very subjective determination. According to the procedure, the samples to be tested are provided to a panel of ten odor specialists who independently rank odor intensity of the dry laundered fabric using a scale of 1 (no perceived odor) to 10 (high odor intensity). Samples yielding an odor ranking below about 2 possess an odor which would hardly be noticed by the general public.

### Incorporation of the Nano Spheres in Fabric Care Products

### EXAMPLE 5

The performance of a liquid laundry detergent product comprising the fragrance carrier system of Example 1 (i.e., the ability to increase fragrance deposition onto fabric, as well as the ability to prolong fragrance release from the dry laundered fabric over an extended period of time, or yield a high impact fragrance “burst” upon ironing the fabric) was evaluated and compared to the performance of the same detergent comprising the neat fragrance, at the same fragrance level. The unfragranced liquid laundry detergent base was a commercial TIDE™ FREE liquid laundry detergent available from Procter & Gamble Company of Cincinnati, Ohio that is fragrance free. The laundry samples were prepared at a 1% effective fragrance concentration using the fragrance described in Example 1. The control sample was prepared by weighting into a jar 1 gram of the neat fragrance and 99 grams of the TIDE™ FREE unfragranced and the resulting mixture was mixed for about one hour. The liquid laundry detergent comprising the fragrance spheres of the present invention was prepared by weighting into a jar 3.3 grams of the fragrance spheres of example 2 and 96.7 grams of the TIDE™ FREE unfragranced liquid laundry detergent base and the resulting mixture was mixed for about one hour.

Twenty towels were placed in the washing machine (10 of the towels used were 100% cotton and the other 10 towels were 65% polyester and 35% cotton) with 100 grams of powder laundry detergent dosed directly into the washing machine.

The following washing machine cycle was used:
Fabric Load: 20 towels
Laundry detergent sample size: 100 grams
Dosing into the machine: Laundry detergent was dosed directly into the machine
Water level: Small Load
Water temperature: Cold/Cold Cycle: Short cycle

Water temperature: Cold/Cold Rinse options: One rinse cycle Speeds: Heavy duty Cloth samples were line-dried for 24 hours and then evaluated at four stages: immediately after drying (24 hours following wash); upon ironing 24 hours following wash; at one week after drying; and at two weeks after drying. The dry fabric was folded into two and placed into an aluminum tray, approximately 5 cm deep, covered with a perforated aluminum sheet, between the evaluation stages, up to the moment of the sniff-test. The sniff-test was performed on the dry laundered fabric in a “pre-ventilated” room by ten graders, and test results are presented below:

| | 24 Hours Following Wash | |
|---|---|---|
| Sample | Dry Fabric | Upon Ironing |
| Neat Fragrance (Control) | 3 | 4 |
| Encapsulated Fragrance (Example 1) | 6 | 8 |

Test results indicate that the cloth samples washed with the encapsulated fragrance of Example 1 are significantly more intense than the control samples washed with the neat fragrance immediately after drying (24 hours following wash).

A significant increase in fragrance intensity was observed upon ironing the fabric laundered with the encapsulated fragrance spheres of Example 1. Although odor intensity of the fabric laundered with the neat fragrance (control) was observed to be directly more intense, upon ironing, no significant increase in odor intensity was observed. Only a slight increase in odor intensity was observed when ironing the fabric laundered with the neat fragrance (control).

| Sample | One Week | Two Weeks |
|---|---|---|
| Neat Fragrance (Control) | 2 | 1 |
| Encapsulated Fragrance (Example 1) | 6 | 5 |

At week one and week two the test results indicate that the cloth samples washed with the encapsulated fragrance of Example 1 are significantly more intense than the 35 control samples washed with the neat fragrance (control). The products comprising the encapsulated fragrance show significant improvement over the performance of the neat fragrance in sustaining the volatile constituents of the fragrance and providing a prolong fragrance release from the dry laundered fabric over an extended period of time.

### Incorporation of the Nano Spheres in Hair Care Products

### EXAMPLE 6

The ability of the nano spheres of Example 2 to extend the release of the fragrance was determined by evaluating the menthol odor intensity retained on hair washed with a shampoo composition comprising the nano spheres of Example 2.

10 grams of the suspension of Example 2 is admixed with 90 grams of a shampoo base (30% concentrated shampoo base #4, product of JEEN International Corporation, of Little Fall, N.J. and 70% water) to create a shampoo sample containing 1.0% fragrance. A control sample was created by admixing 1.0 gram of fragrance with the above shampoo base.

Four hair swatches were washed with the shampoo sample comprising the nano-spheres of Example 2 and four hair swatches were washed with the control sample comprising the neat fragrance. Two of the hair swatches in each experimental set (two washed with the shampoo comprising the nano-spheres and two washed with the control sample) were dried using a blow dryer. The intensity of the fragrance retained on the wet swatches and the odor emitted 1 minute after drying the hair with a blow dryer was 25 evaluated using a scale of 1 to 10, where 1 measures a low odor intensity and odor intensity of 10 measures a high intensity, pleasant odor. Odor perception is, by its nature, a very subjective determination and therefore needs to be determined by a panel of trained odor evaluator. According to the procedure, the hair swatches tested were provided to a panel of six odor evaluators who independently rank odor intensity retained 30 on the wet hair swatches and in the proximate environment, 1 minute after blow drying the hair. The odor evaluation results were as follows:

| Wet Hair | One Minute After Blow-Drying |
|---|---|
| Neat Fragrance (Control) | 3 |
| Fragrance in Nano Spheres | 6 |

These results show that the hair swatches washed with the control samples, comprising the neat fragrance, had very low odor intensity. The hair swatches washed with the shampoo comprising the fragrance in the nano spheres had higher odor intensity. Thus, the nano spheres of the present invention adhere to hair and can be utilize to deposit higher level of fragrance onto hair. Only the hair swatches washed with the 15 shampoo comprising the nano-spheres provided high impact fragrance “burst” upon blow drying the hair. Thus, the nano spheres of the present invention have the ability to provide heat triggered release of the active agents and yield high impact odor “burst” upon blow drying the hair or other type of heat treatment.

The other four hair swatches (washed with the shampoo comprising the nano-spheres and the control sample) were air-dried and odor intensity of the fragrance retained on the dry swatches was evaluated after one hour and after 8 hours using the same scale as above. According to the procedure, the hair swatches to be tested were provided to a panel of six odor evaluators who independently rank odor intensity retained on the hair swatches. The odor evaluation results after one hour and after 8 hours, on the dry hair swatches were as follows:

| | Neat Fragrance (Control) | Fragrance in Nano Spheres |
|---|---|---|
| One Hour | 2 | 5 |
| 8 Hours | 1 | 4 |

These results show that the hair swatches washed with the control samples, comprising the neat fragrance, had very low odor intensity. The hair swatches washed with the shampoo comprising the fragrance in the nano spheres had higher odor intensity. Thus, the nano spheres of the present invention adhere to hair and can be utilize to deposit higher level of fragrance onto hair. Odor intensity of the hair swatches washed with the shampoo comprising the fragrance in the nano spheres, after 8 hours, was significantly higher than that of the swatches washed with these products comprising the neat fragrance. Also, Odor intensity of the hair swatches washed with the shampoo comprising the menthol in the nano-spheres, remain almost the same as after one hour. Thus, the nano-spheres of the present invention have the ability to sustain the release of active ingredients and provide extended release, even for volatile ingredients such as fragrances. The release rate of the fragrance, or other sensory markers, can be chronize with that of the active agent to convey to the consumer the product performance.

### EXAMPLE 7

The ability of the nano-spheres of Example 2 to extend the release of active agents and sensory markers (i.e., a fragrance) was determined by evaluating the odor intensity retained on hair washed with a hair conditioner composition comprising the nano-spheres of Example 2.

10 grams of the suspension of Example 2 is admixed with 90 grams of a 30 conditioner base (40% Jeequat ASP, product of JEEN International Corporation, of Little Fall, N.J. and 60% water) to create a hair conditioner sample containing 1% fragrance. A control sample was created by admixing 1 gram of the neat fragrance with the above conditioner base.

Two hair swatches were washed with the conditioner sample comprising the nano-spheres of Example 2 and two hair swatches were washed with the control sample comprising the neat fragrance. The hair swatches were air dried and odor intensity of the fragrance retained on the dry swatches was evaluated after one hour and after 24 hours. Odor perception is, by its nature, a very subjective determination. According to the procedure, the hair swatches to be tested were provided to a panel of six odor evaluators who independently rank odor intensity retained on the hair swatches using a scale of 1 (neutral, low odor intensity) to 10 (high, pleasant, odor intensity). The odor evaluation results after one hour and after 24 hours, on the dry hair swatches were as follows:

| | Neat Fragrance (Control) | Fragrance in Nano Spheres |
|---|---|---|
| One Hour | 4 | 9 |
| 24 Hours | 3 | 8 |

These results show that the hair swatches washed with the control samples, comprising the neat fragrance, had very low odor intensity. The hair swatches washed with the conditioner comprising the fragrance in the nano spheres had higher odor intensity. Thus, the nano spheres of the present invention adhere to hair and can be utilize to deposit higher level of fragrance onto hair. Odor intensity of the hair swatches washed with the conditioner comprising the fragrance in the nano spheres, after 24 hours, was significantly higher than that of the swatches washed with these products comprising the neat fragrance. Also, Odor intensity of the hair swatches washed with the conditioner comprising the fragrance contained in the nano spheres, was almost as high as their odor intensity after one hour. Thus, the nano spheres of the present invention have the ability to sustain the release of active ingredients and provide extended release, even for volatile ingredients such as fragrances. The release rate of the fragrance, or other sensory markers, can be synchronize with that of ascorbic acid, or other active ingredients, to convey to the consumer the product performance.

### EXAMPLE 8

Fragrance carrier particles can be formed having the following composition:
69% Hydrophobic copolymer of a silicon copolymer modified candelilla wax commercially available from Strahl & Pitsch Inc.
1% Cationic conditioning agent of Behenamidopropyl hydroxyethyl dimonium chloride and a fatty quaternary ammonium salt, available as Incroquat Behenyl HE, from Croda Inc. Parsippany, N.J. and
30% Fragrance.

The hydrophobic polymer and cationic conditioning agent can be melted together to form a clear solution at 90° C. The fragrance can be added to the molten mixture while mixing it with a propeller mixer. This molten solution is atomized into a chamber with ambient temperature air passing through the chamber. The atomized droplets freeze into solid particles in the size range of about 20 microns to about 150 microns.

### EXAMPLE 9

An acidic hard surface cleaner can be formed comprising the fragrance carrier particles of the suspension of Example 2 as follows:

Weight %

| | |
|---|---|
| Citric Acid (50% solution) | 12.0 |
| C12-15 linear alcohol ethoxylate with 3 moles of EO | 5.0 |
| Alkylbenzene sulfonic acid | 3.0 |
| Fragrance carrier particles | 6.0 |
| Water | 74.0 |

### EXAMPLE 10

A basic hard surface cleaner can be formed comprising the fragrance carrier particles of the suspension of Example 2 as follows:

| | Weight % |
|---|---|
| Sodium tripolyphosphate | 2.0 |
| Sodium silicate | 1.9 |
| NaOH (50% solution) | 0.1 |
| Dipropylene glycol monomethyl ether | 5.0 |
| Octyl polyethoxyethanol, 12-13 moles EO | 1.0 |
| Fragrance carrier particles | 6.0 |
| Water | 84.0 |

### EXAMPLE 11

An automatic dishwashing powder can be formed comprising the fragrance carrier particles of Example 8 as follows:

| | Weight % |
|---|---|
| Sodium tripolyphosphate | 25.0 |
| Sodium carbonate | 25.0 |
| C12-15 linear alcohol ethoxylate with 7 moles of EO | 3.0 |
| Fragrance carrier particles | 2.0 |
| Sodium sulfate | 45.0 |

### EXAMPLE 12

A powdered carpet cleaner can be formed comprising the fragrance carrier particles of 8 as follows:

| | Weight % |
|---|---|
| Sodium bicarbonate | 20.0 |
| Benzyl benzoate | 5.0 |
| Amorphous silica | 5.0 |
| Fragrance carrier particles | 2.0 |
| Sodium sulfate | 68.0 |

### EXAMPLE 13

A carpet shampoo can be formed comprising the fragrance carrier particles of the suspension of Example 2 as follows:

| | Weight % |
|---|---|
| C 13-15 alcohol alkoxylate EO/PO copolymer | 3.5 |
| Nitrilotriacetic acid Na₃ (40%) | 2.0 |
| Sodium tripolyphosphate | 6.0 |
| Sodium silicate | 4.0 |
| Amphoteric surfactant, low foam | 5.5 |
| Fragrance carrier particles | 6.0 |
| Water | 73.0 |

### EXAMPLE 14

A spray furniture polish can be formed comprising the fragrance carrier particles of the suspension of Example 2 as follows:

| | Weight % |
|---|---|
| Paraffin oil | 18.0 |
| Silicone oil | 3.5 |
| Sorbitan monooleate emulsifier | 1.0 |
| Carnauba wax | 1.0 |
| Beeswax | 0.5 |
| Fragrance carrier particles | 6.0 |
| Water | 70.0 |

### EXAMPLE 15

A powder toilet cleaner can be formed comprising the fragrance carrier particles of Example 8 as follows:

| | Weight % |
|---|---|
| Sodium carbonate | 10.0 |
| Sodium chloride | 4.0 |
| Linear alkylbenzene sulfonate | 0.5 |
| Fragrance carrier particles | 2.0 |
| Sodium hydrogen sulfate | 83.5 |

### EXAMPLE 16

A hand dishwashing liquid can be formed comprising the fragrance carrier particles of the suspension of Example 2 as follows:

| | Weight % |
|---|---|
| Amido-sulfonate surfactant | 25.0 |
| Fragrance carrier particles | 6.0 |
| Water | 69.0 |

### EXAMPLE 17

A glass cleaner can be formed comprising the fragrance carrier particles of the suspension of Example 2 as follows:

| | Weight % |
|---|---|
| Alcohol alkoxylate surfactant | 0.2 |
| Isopropanol | 10.0 |
| Ammonia liquor (28%) | 3.0 |
| Fragrance carrier particles | 6.0 |
| Water | 80.8 |

### EXAMPLE 18

A tile cleaner can be formed comprising the fragrance carrier particles of the suspension of Example 2 as follows:

| | Weight % |
|---|---|
| Tetrasodium EDTA (40%) | 10.0 |
| Sodium carbonate | 4.0 |
| Amphoteric surfactant | 3.0 |
| Fragrance carrier particles | 6.0 |
| Water | 77.0 |

### EXAMPLE 19

A foaming bathroom cleaner can be formed comprising the fragrance carrier particles of the suspension of Example 2 as follows:

| | Weight % |
|---|---|
| Alpha olefin sulfonates | 3.0 |
| Fatty acid alkanol amides | 3.0 |
| Isopropanol | 10.0 |
| Sodium EDTA | 3.0 |
| Fragrance carrier particles | 6.0 |
| Water | 75.0 |

### EXAMPLE 20

A room deodorizer can be formed comprising the fragrance carrier particles of the suspension of Example 2 as follows:

| | Weight % |
|---|---|
| Paraffinic solvent | 6.0 |
| Fragrance carrier particles | 6.0 |
| Soyethyl morpholinium ethosulfate deodorizer | 1.0 |
| Emulsifiers | 0.5 |
| Triethanolamine | 0.2 |
| Water | 86.3 |

### EXAMPLE 21

The particles of the present invention can be incorporated into an animal litter to provide a long lasting fragrance to the product.

An animal litter product can be formed comprising the fragrance carrier particles of Example 8 as follows:

| | Weight % |
|---|---|
| Soyethyl morpholinium ethosulfate deodorizer | 1.0 |
| Fragrance carrier particles | 2.0 |
| Sodium bentonite clay | 97.0 |

### EXAMPLE 22

The particles of the present invention can be incorporated into a wipe.

The wipe can be formed by spraying the wipe with the fragrance carrier particles of the suspension of Example 2.

### EXAMPLE 23

The particles of the present invention can be incorporated into a wipe.

The wipe can be formed by incorporating the fragrance carrier particles of Example 8 between layers of the wipe.

It is understood that the above-described embodiments are illustrative of only a few of the many possible specific embodiments which can represent applications of the principles of the invention. Numerous and varied other arrangements can be readily derived in accordance with these principles by those skilled in the art without departing from the spirit and scope of the invention.

1. A controlled delivery system for a household product comprising:
a solid sphere comprising an active agent and a cationic conditioning agent.

2. The system of claim 1 wherein said solid sphere further comprises a hydrophobic polymer, hydrophobic copolymer, hydrophobic wax or a mixture thereof.

3. The system of claim 2 wherein said hydrophobic polymer, hydrophobic copolymer or mixture thereof is present in an amount of about 1% to about 95% by weight, said cationic conditioning agents are present in an amount of about 0.01% to about 60% by weight, and said active agent is present in an amount of about 1% to about 70% by weight.

4. The system of claim 2 wherein said particle has a melting point between about 30° C. to about 100° C.

5. The system of claim 2 wherein said hydrophobic polymer or hydrophobic copolymer is selected from a group consisting of: fatty acid esters, fatty alcohols, natural waxes, synthetic waxes, hydrogenated plant oils, biodegradable natural polymers, synthetic polymers, polyethylene homopolymers; ethylene-acrylic acid copolymer; polyamide polymer having a molecular weight in the range of from about 6,000 up to about 12,000; silicon synthetic wax copolymer; silicon natural wax copolymer; candelilla silicon copolymer, and ozokerite silicon copolymer.

6. The system of claim 1 where said sphere has an average particle diameter of from about 0.01 micron to about 10 microns.

7. The system of claim 6 wherein said average particle diameter is from about 0.01 microns to about 1 micron.

8. The system of claim 1 wherein said system is a dispersion of said solid sphere in an aqueous phase.

9. The system of claim 1 wherein said solid sphere further comprises a cationic charge booster.

10. The system of claim 9 wherein said cationic charge booster is selected from the group consisting of polyvinyl amine, polyamine, polyalkyleneimine, a poly-quaternary ammonium compound and a quaternary ammonium compound having the formula, 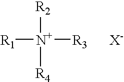
wherein X is an anion and R₁, R₂, R₃, and R₄ are each independently C₁-C₂₂ alkyl, C₃-C₂₂ alkenyl, or R₅-Q-(CH₂)ₘ—, wherein R₅ is C₁-C₂₂ alkyl or alkenyl moiety having from 1 to 22 carbon atoms, and mixtures thereof, m is from 1 to about 6;
and when taken together with the Q unit is an acyl unit, Q can be derived from a source of triglyceride selected from the group consisting of tallow, partially hydrogenated tallow, lard, partially hydrogenated lard, vegetable oils, partially hydrogenated vegetable oils, such as canola oil, safflower oil, peanut oil, sunflower oil, corn oil, soybean oil, tall oil, rice bran oil, and the like and mixtures thereof.

11. The system of claim 1 wherein said cationic charge boosters comprises polyethyleneimine or polyethyleneamine.

12. The system of claim 1 further comprising a cationic charge booster in an aqueous phase of a dispersion of said sphere.

13. The system of claim 12 wherein said cationic charge booster is selected from the group consisting of polyvinyl amine, polyamine, polyalkyleneamine, polyalkyleneimine, a poly-quaternary ammonium compound and a quaternary ammonium compound having the formula, 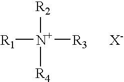
wherein X is an anion and R₁, R₂, R₃, and R₄ are each independently C₃-C₂₂ alkyl, C₃-C₂₂ alkenyl, or R₅-Q-(CH₂)ₘ—, wherein R₅ is C₁-C₂₂ alkyl or alkenyl moiety having from 5 to 22 carbon atoms, and mixtures thereof, m is from 1 to about 6; and when taken together with the Q unit is an acyl unit, Q can be derived from a source of triglyceride selected from the group consisting of tallow, partially hydrogenated tallow, lard, partially hydrogenated lard, vegetable oils, partially hydrogenated vegetable oils, such as canola oil, safflower oil, peanut oil, sunflower oil, corn oil, soybean oil, tall oil, rice bran oil, and the like and mixtures thereof.

14. The system of claim 12 wherein said cationic charge boosters comprises polyethyleneimine or polyethyleneamine.

15. The system of claim 12 wherein said cationic charge booster is present in an amount up to about 10% by weight of the aqueous phase.

16. The system of claim 1 wherein said cationic conditioning agents are selected from a group consisting of straight-chain alkylammonium compounds, cyclic alkylammonium 20 compounds, petroleum derived cationic compounds, and cationic polymers.

17. The system of claim 1 wherein said cationic conditioning agent comprises cetyl trimethylammonium chloride.

18. The system of claim 1 wherein said cationic conditioning agent comprises behenamidopropyl hydroxyethyl dimonium chloride.

19. The system of claim 1 wherein said cationic conditioning agent comprises polyquaterium-24.

20. The system of claim 1 wherein said cationic conditioning agent comprises quaternium-82.

21. The system of claim 1 wherein the cationic conditioning agent is present in an amount of about 0.01% to about 70% by weight of the sphere.

22. The system of claim 1 wherein said active agent comprises a fragrance.

23. The system of claim 22 wherein said fragrance has a ClogP in the range of about 1 to about 8.

24. The system of claim 1 wherein said spheres release said cationic conditioning agent over an extended period of time.

25. The system of claim 1 wherein said particle releases an effective amount of said cationic conditioning agent to provide a burst upon heat treatment of said particle.

26. A household product comprising the system of claim 1.

27. The household product of claim 26 wherein said household product is selected from the group consisting of dishwashing detergent, surface cleaner, deodorizer, animal litter and cleaning wipe.

28. The household product of claim 27 wherein said dishwashing detergent is selected from the group consisting of an automatic dishwashing detergent powder, an automatic dishwashing detergent liquid and a hand dishwashing detergent.

29. The household product of claim 27 wherein said surface cleaner is selected from the group consisting of acid hard surface cleaner, basic hard surface cleaner, tile cleaner, glass cleaner, bathroom surface cleaner, furniture polish, carpet powder cleaner, carpet shampoo, automotive cleaner, automotive wax and automotive polish.

30. The household product of claim 27 wherein said household product is a cleaning wipe, said cleaning wipe comprising one or more layers of a material.

31. The household product of claim 30 wherein said solid particles are adhered to said one or more layers of material.

32. The household product of claim 30 wherein said solid particle is held between a plurality of said layers.

33. The household product of claim 30 wherein said one or more layers of material are selected from the group consisting of nonwoven materials, woven materials and hydroentangled materials.

34. A method of soil removal with a controlled delivery system which is a solid particle, said solid particle comprising an active agent and a cationic charge booster, said solid particle being formed of a hydrophobic polymer, hydrophobic copolymer, or a mixture thereof.

35. A method of deodorizing with a controlled delivery composition system which is a solid particle an active agent and a cationic charge booster, said solid particle being formed of a hydrophobic polymer, hydrophobic copolymer, or a mixture thereof.

36. A method of producing a controlled release system for fabric comprising the steps of:
heating a matrix material of a hydrophobic polymer to a temperature above the material melting point;
dissolving or dispersing a cationic conditioning agent into the melt; dissolving or dispersing an active agent into the melt;
heating the melt to a temperature above the melting point of the melt; mixing the hot melt with an aqueous solution to form a suspension;
high shear homogenization of the suspension at a temperature above the melting temperature until a homogeneous fine suspension is obtained; and
cooling the suspension to ambient temperature to create a fine dispersion.
